(19) United States
(12) Patent Application Publication
(10) Pub. No.: US 2019/0244515 A1
(43) Pub. Date: Aug. 8, 2019

(54) AUGMENTED REALITY DSRC DATA VISUALIZATION

(71) Applicant: Continental Automotive Systems, Inc., Auburn Hills, MI (US)

(72) Inventors: Jesse Aaron Hacker, West Bloomfield, MI (US); Bastian Zydek, Bad Soden (DE)

(73) Assignee: Continental Automotive Systems, Inc., Auburn Hills, MI (US)

(21) Appl. No.: 16/140,076

(22) Filed: Sep. 24, 2018

Related U.S. Application Data
(60) Provisional application No. 62/562,920, filed on Sep. 25, 2017.

(51) Int. Cl. G08G 1/01; G08G 1/16; B60K 35/00; G06T 7/70; H04W 4/44

(52) U.S. Cl. CPC G08G 1/0116; G08G 1/166; B60K 35/00; G06T 7/70; B60K 2370/1529; G08G 1/0141; G06T 2207/30241; G06T 2207/30261; B60K 2370/177; H04W 4/44

(57) ABSTRACT

One general aspect includes a method for displaying an augmented image including: recording data with at least one sensor at an intersection. The method also includes transmitting the data via a DSRC to a second DSRC in a vehicle proximate to the intersection; analyzing the data with a processor to determine the location of an object proximate to the intersection; and augmenting an image by bounding a portion of an image of the intersection, where the coordinates of the bounded portion corresponds to a location of the object in the intersection. The method also includes displaying the augmented image on a display in view of a vehicle operator when at least one vulnerable road user is crossing the intersection.

### FIELD OF THE INVENTION

The invention relates generally to a system for warning a driver of a vehicle and more particularly warning a driver there may be a potential danger hidden from the driver's line of sight.

### BACKGROUND OF THE INVENTION

Signalized and unsignalized intersections and cross-walks for pedestrians present one of the most dangerous areas where accidents may occur, such as an automobile hitting a pedestrian. Additionally, pedestrians are also distracted by cell phones, tablet computers, billboards, other pedestrians, and the like, which may limit the ability of the pedestrian to be fully aware of any dangers resulting from vehicles that may be driving unsafely. Further, the driver of a vehicle may not be able to see around other vehicles or buildings to oncoming traffic or traffic about to turn a corner.

Currently, there are many types of systems in place, which are part of a vehicle, to make a driver of the vehicle aware of potential dangers with regard to collisions with pedestrians, other vehicles, and other objects along the side of a road. Some crosswalks also have systems in place which provide blinking lights to alert drivers of approaching vehicles that at least one vulnerable road user is crossing the crosswalk. However, these systems can only alert the driver to objects or potential collisions that can be directly sensed by the vehicle sensors.

Accordingly, there exists a need for a warning system, which may be part of the infrastructure of an urban environment, to alert the driver of a vehicle to potential dangers not visible by the driver and/or not sensed by the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### SUMMARY

One general aspect includes a method for displaying an augmented image including: recording data with at least one sensor at an intersection. The method also includes transmitting the data via a dedication short range communication (DSRC) device to a second DSRC device in a vehicle proximate to the intersection; analyzing the data with a processor to determine the location of an object proximate to the intersection; and augmenting an image by bounding a portion of an image of the intersection, where the coordinates of the bounded portion corresponds to a location of the object in the intersection. The method also includes displaying the augmented image on a display in view of a vehicle operator when at least one vulnerable road user is crossing the intersection.

One general aspect includes an augmented visualization system for a vehicle including a communication device in a vehicle proximate to an intersection configured to receive data from at least one sensor at an intersection. A processor configured with instructions for: analyzing the data with a processor to determine the location of an object proximate to the intersection; and augmenting an image by bounding a portion of an image of the intersection, where the coordinates of the bounded portion corresponds to a location of the object in the intersection. The augmented visualization system also includes a display in view of a vehicle operator, where the augmented image is shown.

One general aspect includes an intersection monitoring system including: at least one sensor at an intersection, an intersection processor configured with instructions for: analyzing the data from the at least one sensor to determine the location of an object proximate to the intersection determining coordinates of a location of the object in the intersection; and a first communication device configured to broadcast data from the processor to at least one second communication device proximate to the intersection such that an image for a display may be augmented by bounding a portion of an image which corresponds to the coordinates on the location of the object in the interesting.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present invention will become more fully understood from the detailed description and the accompanying drawings, wherein:

FIG. 1 is a perspective view of a traffic intersection having a warning system being part of an infrastructure component, according to embodiments of the present invention;

FIG. 2A is a schematic illustration of vehicle having a first embodiment of an augmented visualization system, according to embodiments of the present invention;

FIG. 2B is a schematic illustration of vehicle of an exemplary display screen of the first embodiment of an augmented visualization system, according to embodiments of the present invention;

FIG. 2C is perspective view of an object detected by a remote sensor and displayed by the augmented visualization system, according to embodiments of the present invention;

FIG. 3 is a schematic illustration of vehicle having a second embodiment of an augmented visualization system, according to embodiments of the present invention; and

FIG. 4 is a flow diagram of an exemplary arrangement of operations for operating a tow vehicle in reverse for attachment to a trailer.

### DETAILED DESCRIPTION OF THE PREFERRED EMBODIMENTS

The following description of the preferred embodiment(s) is merely exemplary in nature and is in no way intended to limit the invention, its application, or uses Like reference symbols in the various drawings indicate like elements.

In one embodiment, an intersection monitoring system(s) 10 may provide intelligent intersections 20 which may be enabled with communication device 24, such as dedicated short range communication (DSRC) device. The intersection monitoring system 10 may be for detecting objects 14 including vehicles and vulnerable road users proximate to the intersection 20, and broadcasting information about them as a basic safety message (BSM) to another communication device 26. The first communication device 24 may be part of the intersection monitoring system 10 or may be part of another vehicle or smart device proximate to the intersection 20. The information broadcast by the first communication device 24 may be received by a second communication device, 26, possibly another DSRC, in communication enabled vehicles 14a and allow the communication enabled vehicles 14a to warn the drivers of various situations which may be potentially dangerous.

In one embodiment, an augmented vehicle 14b uses an augmented visualization system 12 equipped to visually alert a driver to a potential danger. Since emergency brake assist (EBA) systems have sensors that may accurately determine the location, speed, and direction of objects (pedestrians, cyclists, etc), and may be equipped with V2X technologies and communicate with the smart city infrastructures, key information may be shared to allow for localized warnings. Additionally, this information may be used by the augmented visualization system 12 to determine when to alert a driver to a potential danger.

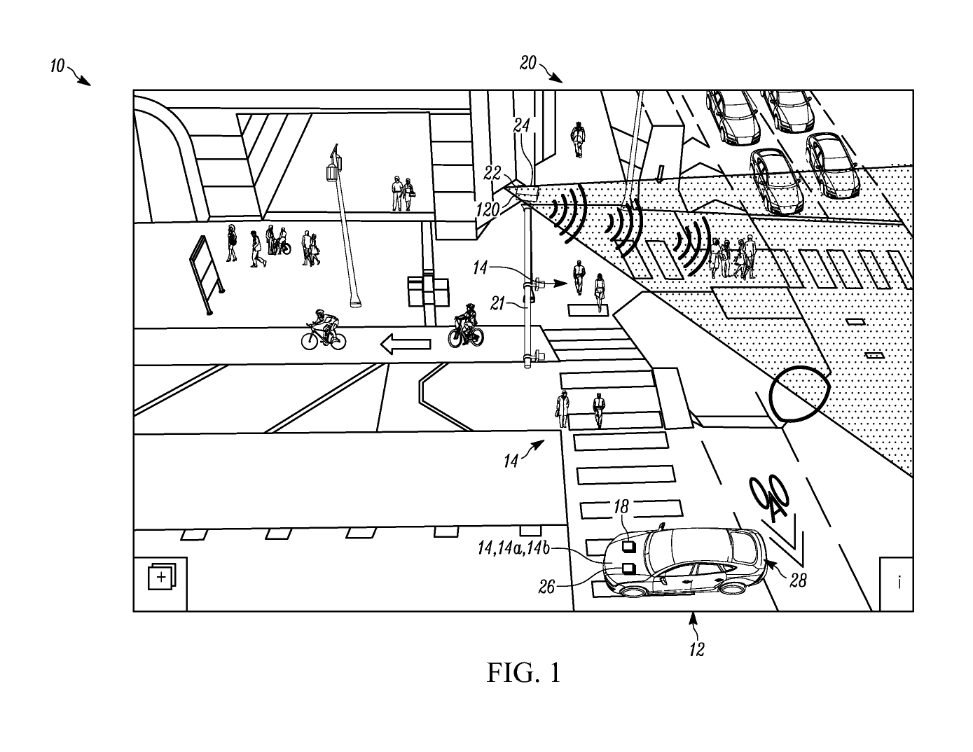

FIG. 1 illustrates an intersection monitoring system 10. The intersection monitoring system 10 is associated with an intersection 20 which includes some type of infrastructure component 21, which in this embodiment is a post, having at least one sensor 22 and at least one first communication device 24. The intersection monitoring system 10 may also have a warning device. While in this embodiment, the infrastructure component 21 is the post, it is within the scope of the invention that the intersection monitoring system 10 and warning system may include any other type of infrastructure component 21, such as a building, bridge, parking structure, support structure, or the like.

In this embodiment, the communication device 24 is enabled with dedicated short range communication (DSRC) to sharing information sensed by the at least one sensor 22 through communications to broadcast information to vehicles 14, 14a, 14b proximate to the intersection or other devices capable of receiving such a communication, such as a smart phone.

In this embodiment, proximate may be interpreted by known dictionary definitions, other definitions known by those skilled in the art, within a distance to receive the communication from the first communication device 24, or within a predetermined physical distance of the intersection 20 predetermined for the intersection monitoring system 10.

In this embodiment, the sensor 22 and communication device 24 are integrated into a single component, the sensor 22 and communication device 24 may be separate components in different locations or multiple types of sensors 22 may be linked to one communication device 24. The sensor 22 in this embodiment is able to detect objects in a detection area, shown generally at 22A. In one embodiment, the sensor 22 is a long-range radar sensor 22, but it is within the scope of the invention that other types of sensors maybe used, such as, but not limited to long-range radar, short-range radar, LIDAR (Light Imaging, Detection, and Ranging), LADAR (Laser Imaging, Detection, and Ranging), and other types of radar, a camera, ultrasound, or sonar.

In the Figures, the sensor 22 is able to detect the location, as well as speed and direction of each object 14, including the location, speed, and direction of vehicles and pedestrians 14. While there are two objects/pedestrians 14 which are walking in the example shown in FIG. 1, it is within the scope of the invention that the sensor 22 is able to detect if each is walking, traveling by bicycle, scooter, skateboard, rollerblades, or the like and may be able to detect many more objects and vehicles 14.

Once the sensor 22 detects the location, as well as speed and direction of each vehicle 14 and the location, speed, and direction of each object 14, the first communication device 24 broadcasts the information to any communication enabled objects/vehicles 14a having a second communication device 26, such as a common DSRC device or otherwise able to receive the information.

The augmented visualization system 12 also includes a visualization system processor 18. The visualization system processor 18 may include at least one of a microprocessor, microcontroller, an application specific integrated circuits (“ASICs”), a digital signal processor, etc., as is readily appreciated by those skilled in the art. The visualization system processor 18 is capable of performing calculations, executing instructions (i.e., running a program), and otherwise manipulating data as is also appreciated by those skilled in the art. The intersection monitoring system 10 also has a processor 16.

The processor 16 is in communication with the at least one sensor 22. As such, the processor 16 may receive data from the various sensors 22. The processor 16 is configured to determine various characteristics of the object 14 based on the data provided by the sensors 22. These characteristics include, but are not limited to, type of object 14 (e.g., motorcycle, truck, pedestrian, car, etc.), size of each object 14, position of each object 14, weight of each object 14, travel speed of each object 14, acceleration of each object 14, and heading for each object 14.

The processor 16 is also configured to estimate the trajectory for each object 14. This estimation is calculated based on at least one of the speed, acceleration, and heading for each object 14. That is, the processor 16 is configured to estimate potential future locations of the object 14 based on current and past location, speed, and/or acceleration. The communication device 24 associated with the sensor 22 and processor 16 then broadcasts the information to the area proximate to the intersection 20. All vehicles having a second DSRC/communication device 26 or an otherwise able communication device to receive the information.

The intersection processor 16 and/or visualization system processor 18 are configured to predict a possibility that the object 14 is not seen by the driver of the vehicle 14a, 14b and, thus, there is a potential danger of collision or accident present. This probability is based, at least in part, on the estimated trajectory for each object 14 that was received from the intersection monitoring system 10. The probability may be a number corresponding to a likelihood of collision based on various factors including the potential future locations of the object 14.

The processor 16 may have access to information regarding traffic signals (not shown) at the intersection 20. The communications may be achieved, for example, by vehicle-to-vehicle communication (“V2V”) techniques and/or vehicle-to-X (“V2X”) techniques. In one embodiment, the processor 16 may be in communication with a signal controller (not shown) to determine the state of the various traffic signals (e.g., “green light north and southbound, red light east and westbound”, etc.). In another embodiment, the processor 16 may determine the state of the traffic signals based on data provided by the sensors 22. This information can be included in the broadcast from the DSRC 24 to vehicles 14a in the vicinity of the intersection 20. The vehicle processor 18 may then utilize the information regarding traffic signals in predicting the probability for a collision between objects 14. In particular between the vehicle 14a and other objects 14.

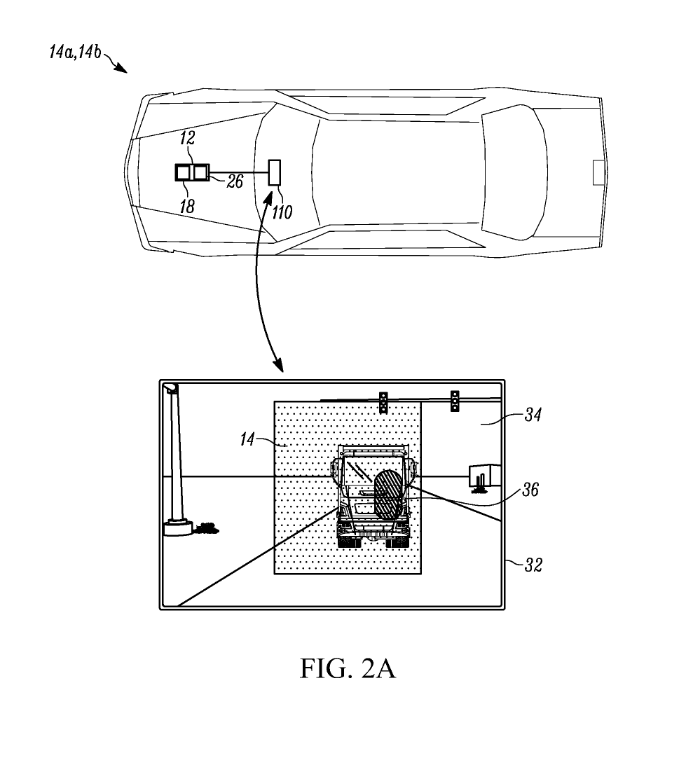

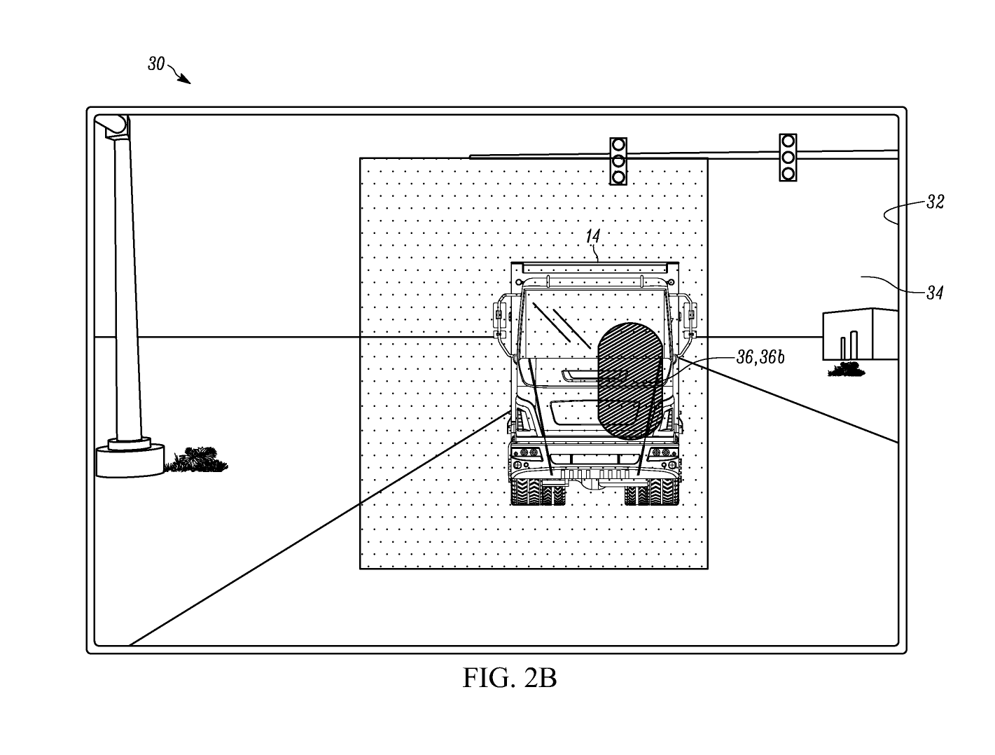

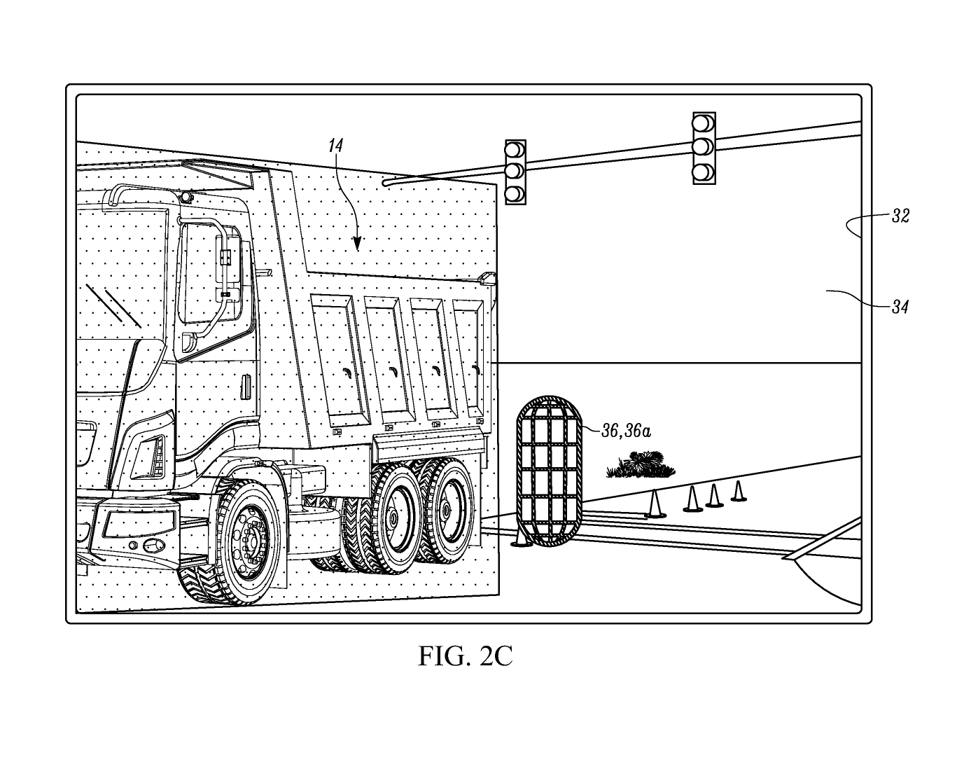

The images and other data from the intersection monitoring system 10 is sent from the DSRC 24 to the vehicle/second DSRC 26. The intersection processor 16 and/or visualization system processor 18 uses the data to determine there is at least one object 14 that possibly cannot be seen, or can be seen but is a potential danger to which the driver's attention should be directed. The vehicle 14b has a user interface 30 for the augmented visualization system 12, including at least one type of display 32. The augmented visualization system 12 displays an image 34 on the display 32. The user interface 30 and display 32 may include a screen, a touch screen, a heads-up display, a helmet visor, a phone display, a windshield, etc. The image 34 may be one captured by an on vehicle camera 28, as shown in FIG. 2B, or may be from a camera 22 that is acting as a sensor for the intersection monitoring system, as shown in FIG. 2C.

The augmented visualization system 12 provides a graphic overlay 36 to highlight and direct the driver's attention to the location of the detected object 14, such as a bounded area 36 of the image 34 around the portion which corresponds to the obstructed object 14. That way the driver of the augmented vehicle 14b is alerted to a potential danger and can take action to minimize the risk of collision or accident. The object 14 with the potential danger can be a pedestrian about to use the cross-walk, as shown in the Figures or another type of potential danger. For example, other situations may be approaching or turning vehicles that are block from view by other vehicles or buildings, etc. One skilled in the art would be able to determine possible situations when a driver may be unable or having difficulty viewing objects that may be sensed by sensors 22 to that are remote from the vehicle intersection 20, but in the area of an intersection 20.

Therefore, the usefulness of DSRC data increases by effective information of the driver of a vehicle via the human machine interfaces 30. In this way the driver will see an overlay 36 of his field of view with Object Data from DSRC objects. This could be: an overlay with bounding volumes around objects 14, when the objects 14 are occluded, this enables the driver/viewer to be aware of a hidden object like e.g. a car or pedestrian or bicyclist; and/or an overlay displaying the field of view of external sensors, FIG. 2C allowing the viewer to be aware of which areas are safely covered via sensors transmitting over DSRC.

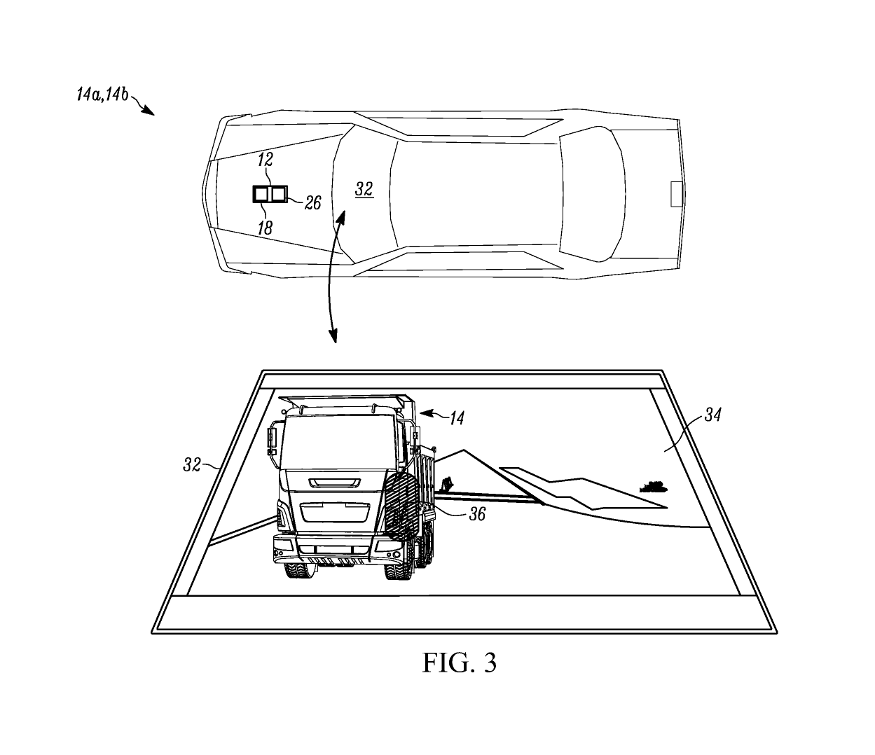

Additional information in the form of text or color-coded graphics to display the state of objects 14. Alternatively, there are various concept HUDs 32 integrated into vehicles 14b that would show a similar visualization. The augmented visualization system 12 could also be implemented into a bicyclist helmet or motorcycle helmet, as well as in smart glass windscreens 14b as shown in FIG. 3. Where the overlay of the bounded area 36 is added on the windscreen 32 which the driver of vehicle 14b is looking through.

The augmented visualization system 12 allows for far greater spatial perception by the driver and awareness of the data. The augmented visualization system 12 scales with the real-life view and leaves far less about a driving scenario open to interpretation.

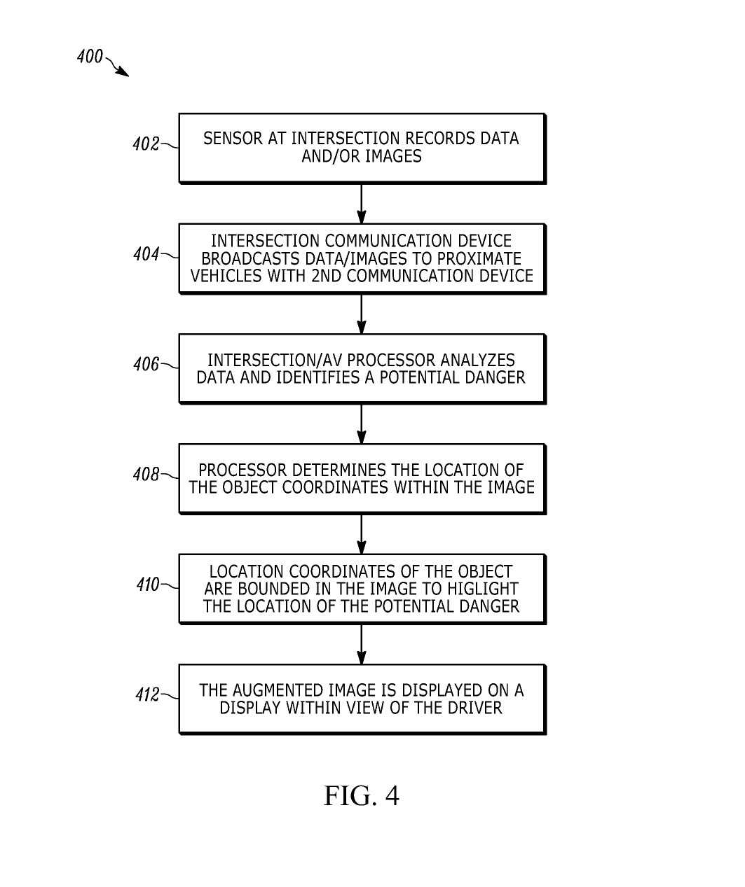

Referring to FIG. 4 a method 200 for displaying an augmented image is described. A sensor 22 at an intersection monitoring system 10 records data and/or images, at block 202. An intersection communication device 24 sends data/images to a second communication device 26 (such as a DSRC device in a vehicle 14a), step 204. An intersection processor 16 and/or augmented visualization system processor 18 for augmented visualization system 12 analyzes data and identifies an object 14 as a Potential Danger either before or after the information is sent, 206. The intersection processor 16 and/or visualization system processor 18 determines the location of the object coordinates within an image 34, at 208. Location coordinates of the object are bounded 36 in the image 34 to highlight the location of the potential danger, at block 210. The augmented image 34 is displayed on a display 32within view of the driver of the vehicle 14b, step 212.

Additionally, the intersection processor 16 and/or visualization system processor 18 identifies seen objects 14 in the image 34 which are identified as areas of obstructed view. The intersection processor 16 and/or visualization system processor 18 can then identify objects 14 that are behind other objects 14 based on the data from the sensors 22. In this embodiment, a truck is parked in the road. The bounded area 36 obstructed by the obstacle 14 is shown in shading for illustrative purposes in FIGS. 2B, 2C and 3, but would not be displayed on the display 32. Additionally, the processor 16 determines if the object 14 can be seen, illustrated to the driver by a first bounding color 36a, e.g. green, as shown in FIG. 2C. If the object 14 is obstructed, it may be illustrated to the driver by a second bounding 36b color, e.g. red as shown in FIG. 2B. Alternatively, or in addition a different patter on the bounding can be displayed as also shown, e.g. cross-hatching vs. solid highlighting.

While this information was explained by example between one vehicle 14b, one intersection 20 and the intersection monitoring system 10 any vehicles 14, 14a, 14b in the proximity of the intersection 20 with the ability to receive and implement the method could benefit in the same manner.

Additionally, while the location and trajectory information is disclosed as being processed by the intersection monitoring system 10 and the potential danger probability and image processing is described as completed by intersection processor 16 and/or visualization system processor 18 other processors may perform the described method in its entirety or in a different combination of processing as illustrated in the example. One skilled in the art would be able to determine which assigned steps should be completed by which processor 16, 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for displaying an augmented image comprising:
recording data with at least one sensor at an intersection:
transmitting the data via a first communication device to a second communication in a vehicle proximate to the intersection;
analyzing the data with a processor to determine a location of a object proximate to the intersection;
augmenting an image by bounding a portion of an image of the intersection, wherein coordinates of the bounded portion corresponds to a location of the object in the intersection; and
displaying the augmented image on a display in view of a vehicle operator when at least one vulnerable road user is crossing the intersection.

2. The method of claim 1, wherein the first communication device and the second communication device are dedication short range communication devices.

3. The method of claim 1, further comprising detecting obstacles in the image between the vehicle and the object.

4. The method of claim 3, wherein the bounded potion is a first color if the object is visible and a second color if the object is obstructed.

5. The method of claim 1, the at least one sensor being one selected from the group consisting of long-range radar, short-range radar, LIDAR, LADAR, camera, ultrasound, and sonar.

6. The method of claim 1, wherein the processor is configured to:
determine at least one of a speed, an acceleration, and a heading for each object based on data from the at least one sensor; and
estimate a trajectory for each object based on at least one of the speed, acceleration, and heading for each object.

7. The method of claim 1, where the display is one of: a screen, a touch screen, a heads-up display, a helmet visor, and a windshield.

8. The method of claim 1, wherein the processor for analyzing the data is part of an intersection monitoring system.

9. The method of claim 1, wherein the processor for analyzing the data is part of the vehicle.

10. An augmented visualization system for a vehicle comprising:
a communication device in a vehicle proximate to an intersection configured to receive data from at least one sensor at an intersection;
a processor for the vehicle configured with instructions for:
analyzing the data with a processor to determine a location of an object proximate to the intersection; and
augmenting an image by bounding a portion of an image of the intersection, wherein coordinates of the bounded portion corresponds to a location of the object in the intersection; and
a display in view of a vehicle operator, wherein the augmented image is shown on the display.

11. The system of claim 10, wherein the communication device is a DSRC, and wherein a second DSRC is associated with the at least one sensor.

12. The system of claim 10, wherein processor is further configured with instructions for detecting obstacles in the image between the vehicle and the object.

13. The system of claim 14, wherein the bounded potion is a first color if the object is visible and a second color if the object is obstructed.

14. The system of claim 10, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.

15. The system of claim 10, wherein processor is further configured with instructions to:
determine at least one of a speed, an acceleration, and a heading for each object based on data from the at least one sensor; and
estimate a trajectory for each object based on at least one of the speed, acceleration, and heading for each object.

16. The system of claim 10, wherein the display is one of: a screen, a touch screen, a heads-up display, a helmet visor, and a windshield.

17. An intersection monitoring system comprising:
at least one sensor at an intersection;
an intersection processor configured with instructions for:
analyzing data from the at least one sensor to determine a location of an object proximate to the intersection; and
determining coordinates of a location of the object in the intersection; and
a first communication device configured to broadcast data from the processor to at least one second communication device proximate to the intersection such that an image for a display may be augmented by bounding a portion of an image which corresponds to the coordinates on the location of the object in the intersection.

18. The system of claim 17, wherein the first communication device is a DSRC, and wherein the second communication device is DSRC is located in at least one vehicle proximate to the intersection to receive the broadcast.

19. The system of claim 17, wherein the communication is broadcast such that any vehicles with a second communication device can receive the broadcast by the first communication device.

20. The system of claim 17, wherein the bounded potion is a first color if the object is visible and a second color if the object is obstructed.

21. The system of claim 17, the at least one sensor being one selected from the group consisting of long-range radar, short-range radar, LIDAR (Light Imaging, Detection, and Ranging), LADAR (Laser Imaging, Detection, and Ranging), camera, ultrasound, and sonar.

22. The system of claim 17, wherein processor is further configured with instructions to:
determine at least one of a speed, an acceleration, and a heading for each object based on data from the at least one sensor; and
estimate a trajectory for each object based on at least one of the speed, acceleration, and heading for each object.

23. The system of claim 17, wherein the display is one of: a screen, a touch screen, a heads-up display, a helmet visor, a phone display, and a windshield.
